(19) United States
(12) Patent Application Publication
(10) Pub. No.: US 2026/0071670 A1
(43) Pub. Date: Mar. 12, 2026

(54) MODULAR AND ADAPTABLE MULTI-SPEED AND MULTI-REDUCTION AXLE

(71) Applicant: Dana Heavy Vehicle Systems Group, LLC, Maumee, OH (US)

(72) Inventors: Saket KALE, Pune (IN); Anand WAKODE, Pune (IN)

(21) Appl. No.: 18/883,623

(22) Filed: Sep. 12, 2024

(51) Int. Cl. F16H 37/08; B60K 1/00; B60K 17/08; F16H 57/02; F16H 57/031; F16H 57/037; F16H 61/00; F16H 61/04

(52) U.S. Cl. CPC F16H 37/082; B60K 1/00; B60K 17/08; F16H 57/031; F16H 57/037; F16H 61/0059; F16H 61/0403; B60K 2001/001; F16H 2057/02034; F16H 2057/02052; F16H 2200/0021; F16H 2200/2005; F16H 2200/2007

(57) ABSTRACT

Systems and methods for a modular multi-speed and multi-reduction electric axle, comprising an electric motor rotationally coupled to a motor shaft, the motor shaft being coupled to an input shaft via splines, no more than two planetary gearset systems that comprise an annulus gear, planet gears, planet carriers, and a cover, no more than two synchronizers that are coupled to a respective sun gear and axially moveable to engage the sun gear with one of a cover or planet carrier of the respective planetary gearset system, at least two helical gears that engage with each other; and a pinion gear that engages with a ring gear, the ring gear being coupled to a differential.

### TECHNICAL FIELD

The present disclosure relates to a multi-speed and multi-reduction axle with a modular and adaptable arrangement.

### BACKGROUND AND SUMMARY

Electric and hybrid-electric vehicles utilize electric motor-generators that harness energy from electric power sources to provide drive, or augmented drive, to the vehicle. Some types of electric and hybrid vehicles have attempted to deploy electric drive axles due to their increased adaptability and modularity in relation to vehicles with electric motors spaced away from the axles.

However, the inventors have recognized that previous electric drive axles, in practice, have exhibited drawbacks related to axle assembly packaging and gear selection. Certain electric drivetrains designs have made tradeoffs with regard to axle packaging compactness, gear selectability, and structural integrity. For instance, some electric drivetrains have expanded their available gear range at the expense of gearbox compactness. The inventor has recognized the aforementioned issues with previous electric axles and developed a multi-speed and multi-reduction electric axle system that has a modular and adaptable arrangement.

In one example, the multi-speed and multi-reduction electric axle system may include a housing with at least one cover that circumferentially encloses the multi-speed and multi-reduction electric axle system, an electric motor rotationally coupled to a motor shaft, the motor shaft being coupled to an input shaft via splines and a carrier, no more than two planetary gearset systems, each planetary gearset system comprising an annulus gear, a sun gear, planet gears, and a planet carrier, no more than two synchronizers wherein each synchronizer is coupled to a respective sun gear and axially moveable to engage the sun gear with one of the at least one cover of the housing or planet carrier of a respective planetary gearset system, at least two helical gears wherein at least one helical gear is positioned above another helical gear enabling the at least two helical gears to engage with each other and a pinion gear that is coupled to one helical gear via a spline and engages with a ring gear, the ring gear being coupled to a differential. In this way, a multi-speed and multi-reduction electric axle system with a desired level of compactness may be achieved.

Further, different arrangements of the multi-speed and multi-reduction electric axle system may be included as part of a line of electric axles. The line of electric axles may comprise a first transmission with a first arrangement, a second transmission with a second arrangement, and a third transmission with a third arrangement of the multi-reduction electric axle system. By having a modular and adaptable multi-speed and multi-reduction electric axle system wherein different arrangements of the electric axle are part of the line of electric axles, ease of assembly of the electric axle and thus, the line of electric axles may increase and may result in less errors during assembly while achieving a variety of speed and reduction capabilities.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 depicts a first example of a multi-speed and multi-reduction electric axle of a vehicle.

FIG. 2 is a power path diagram for the different operating gears of the multi-speed and multi-reduction electric axle system, depicted in FIG. 1.

FIG. 3 depicts a second example of a multi-speed and multi-reduction electric axle system of a vehicle.

FIGS. 4A and 4B are power path diagrams for the different operating gears of the multi-speed and multi-reduction electric axle system, depicted in FIG. 3.

FIG. 5 depicts a third example of a multi-speed and multi-reduction electric axle system of a vehicle.

FIGS. 6A-6D are power path diagrams for the different operating gears of the multi-speed and multi-reduction electric axle system, depicted in FIG. 5.

FIG. 7 depicts a flowchart diagram of a method for operating a modular multi-speed and multi-reduction electric axle system, according to embodiments described herein.

FIG. 8 depicts a line of electric axles with different arrangements of the multi-reduction electric axle system, according to embodiments described herein.

### DETAILED DESCRIPTION

A multi-speed and multi-reduction electric axle system wherein different embodiments of the multi-speed and multi-reduction electric axle system has different selectable gear ratios is described herein. The different embodiments of the multi-speed and multi-reduction electric axle system may comprise a line of electric axles comprising three transmissions. The different embodiments of the multi-speed and multi-reduction electric axle system may differ in configuration based on a number of synchronizers and planetary gearset systems included in the electric axle system. For example, the multi-speed and multi-reduction electric axle system may be arranged with a housing that is configured with at least one cover and encloses the multi-speed and multi-reduction electric axle system, an electric motor that is rotationally coupled to a motor shaft, an input shaft that is coupled to the motor shaft via splines, a carrier that is coupled to the motor shaft, at least two helical gears that engage with each other, and a pinion gear that is coupled to one of the helical gears via a spline and engages with a ring gear that is coupled to a differential. The at least one cover is positioned on the housing on one side of the multi-speed and multi-reduction electric axle system.

The multi-speed and multi-reduction electric axle system may include no more than two planetary gearset systems and no more than two synchronizers. Each planetary gearset system may include an annulus gear, a sun gear, planet gears, and a planet carrier. Each synchronizer is coupled to a respective sun gear and axially moveable to engage the sun gear with one of the at least one cover of the housing or planet carrier of the respective planetary gearset system. In fact, one synchronizer cone of each synchronizer is coupled to the planet carrier and another synchronizer cone of each synchronizer is coupled to the cover. As an example, one embodiment of the multi-speed and multi-reduction electric axle system may not include any synchronizers or planetary gearset systems and may achieve two reduction ratios, another embodiment may include one synchronizer and one planetary gearset and may achieve three reduction ratios, and a further embodiment may include two synchronizers and two planetary gearset systems and may achieve five reduction ratios.

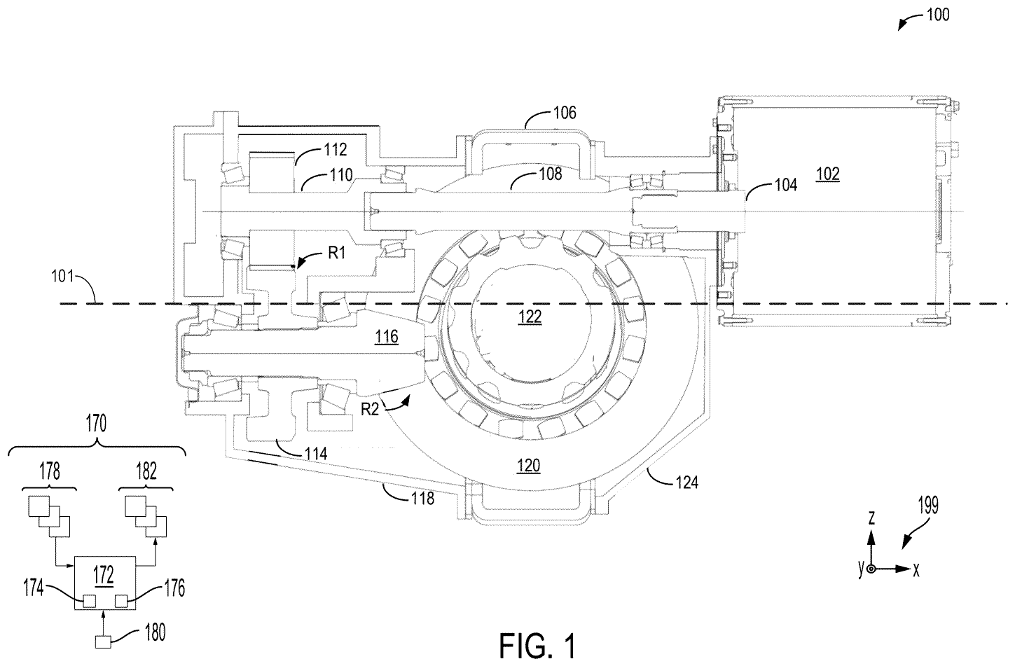

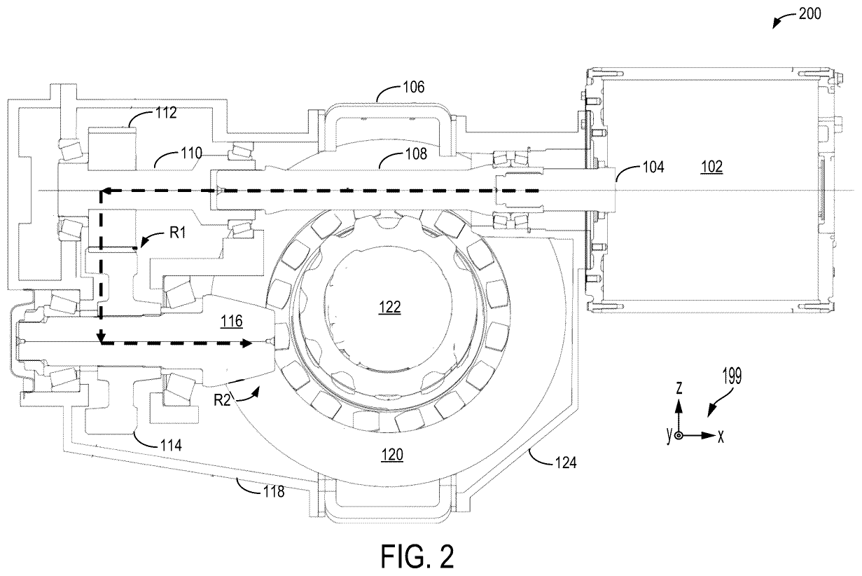

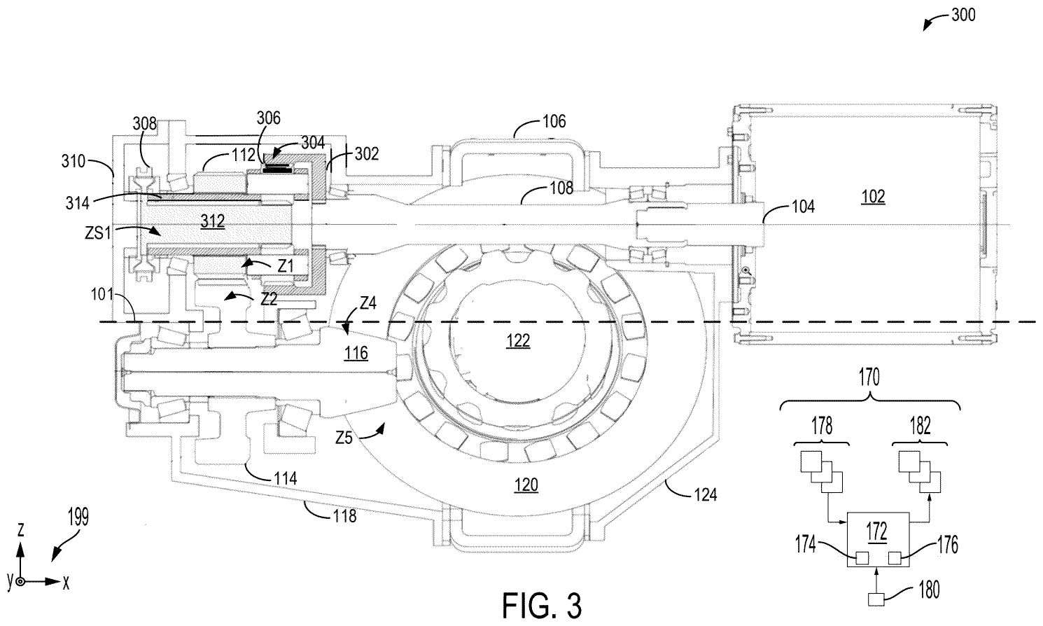

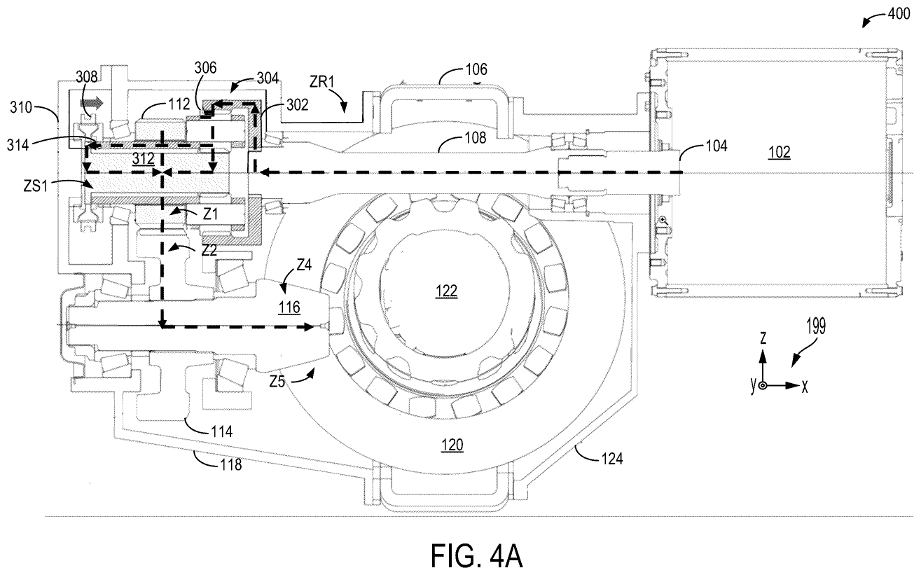

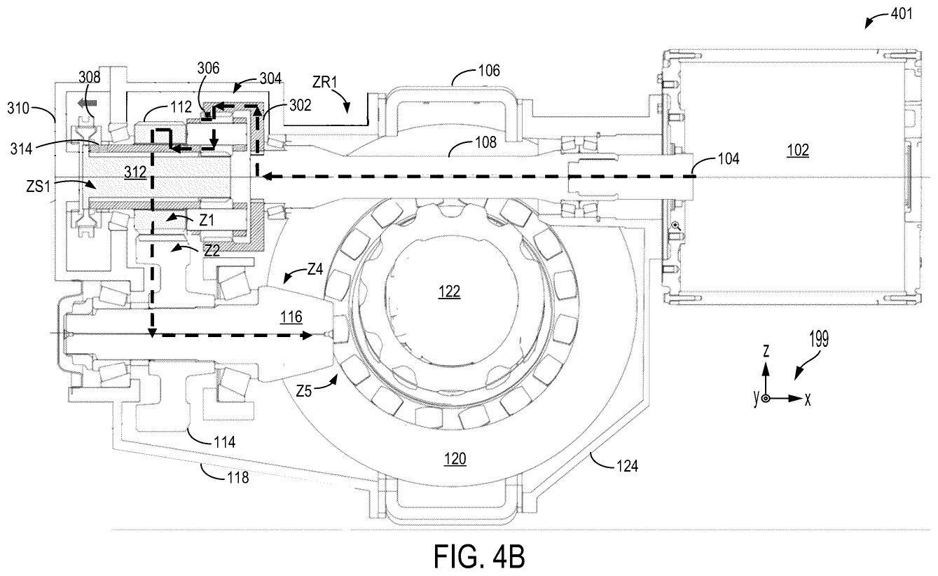

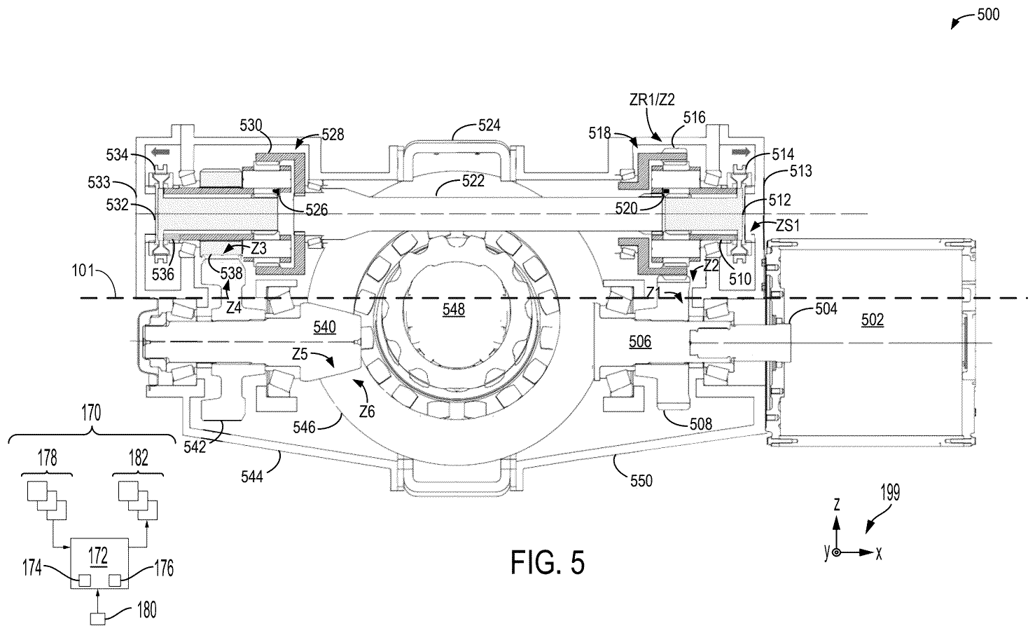

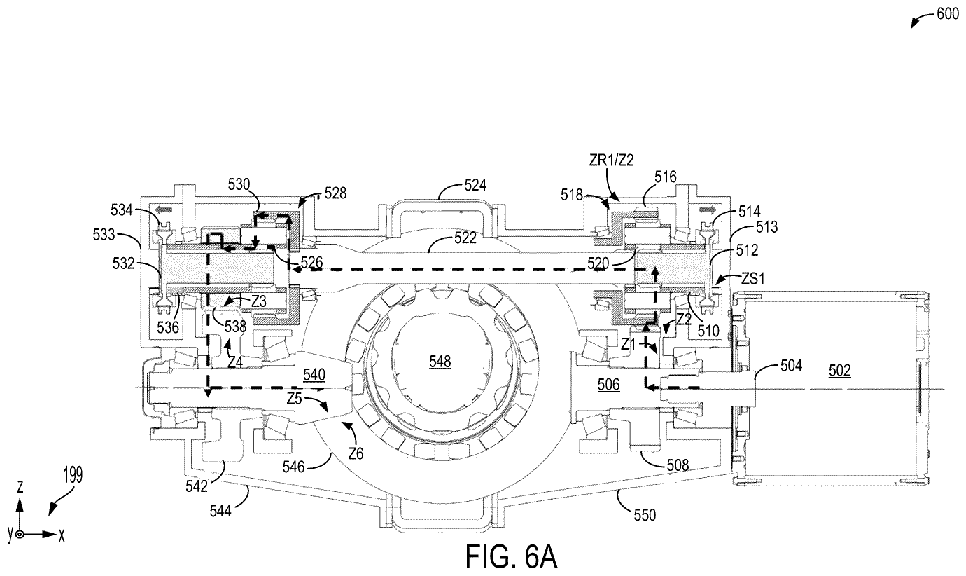

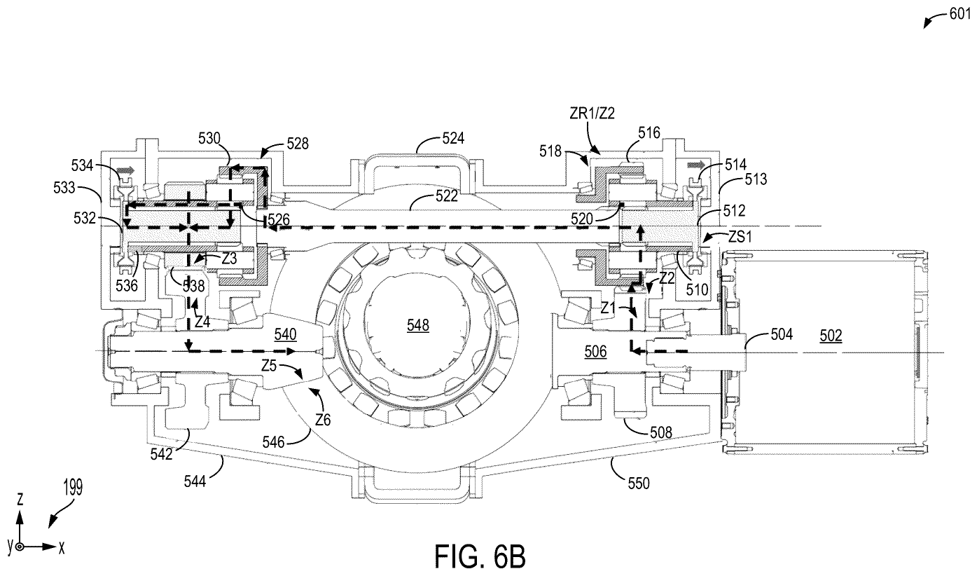

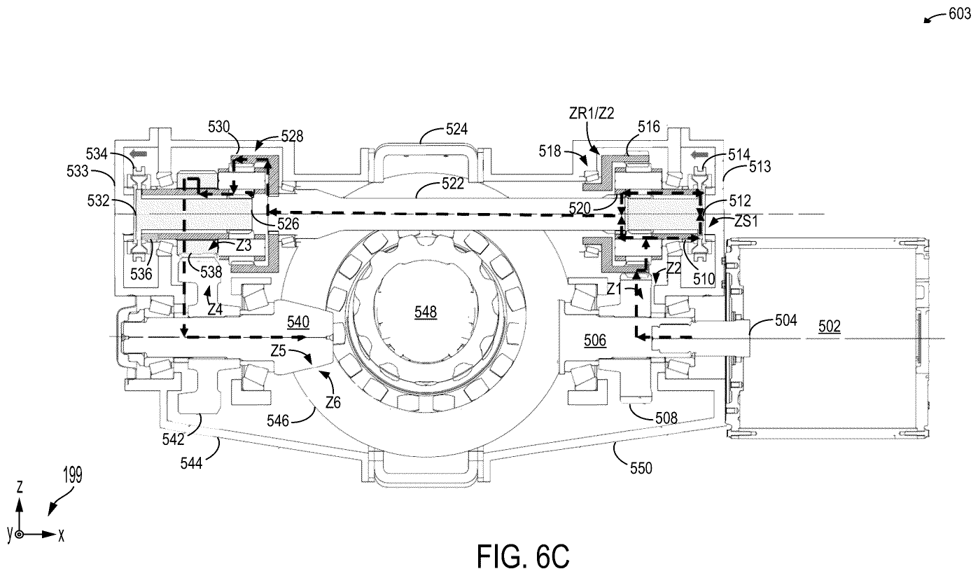

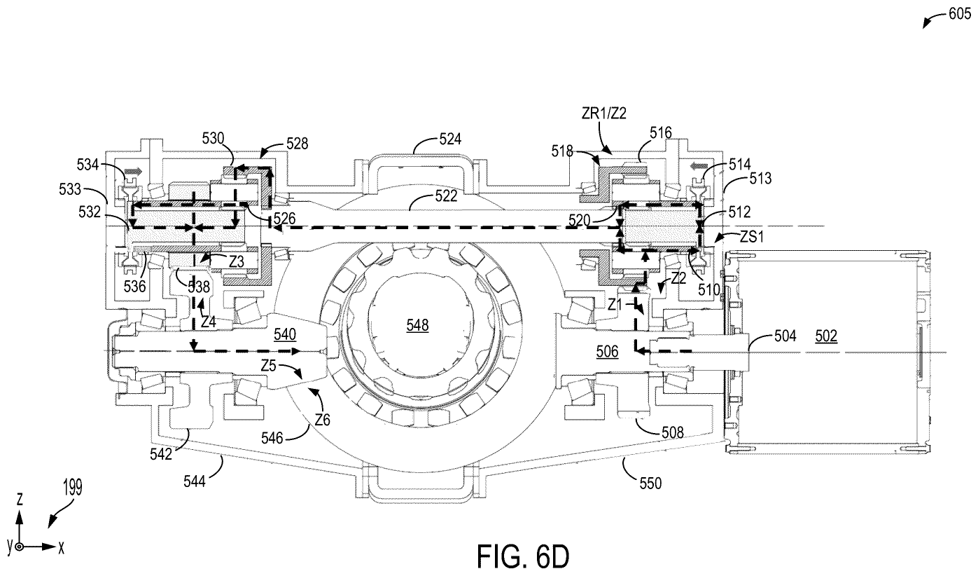

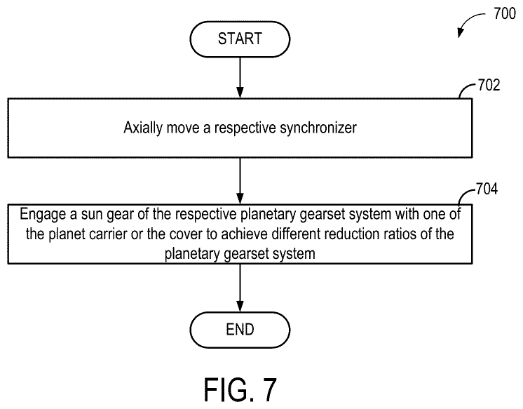

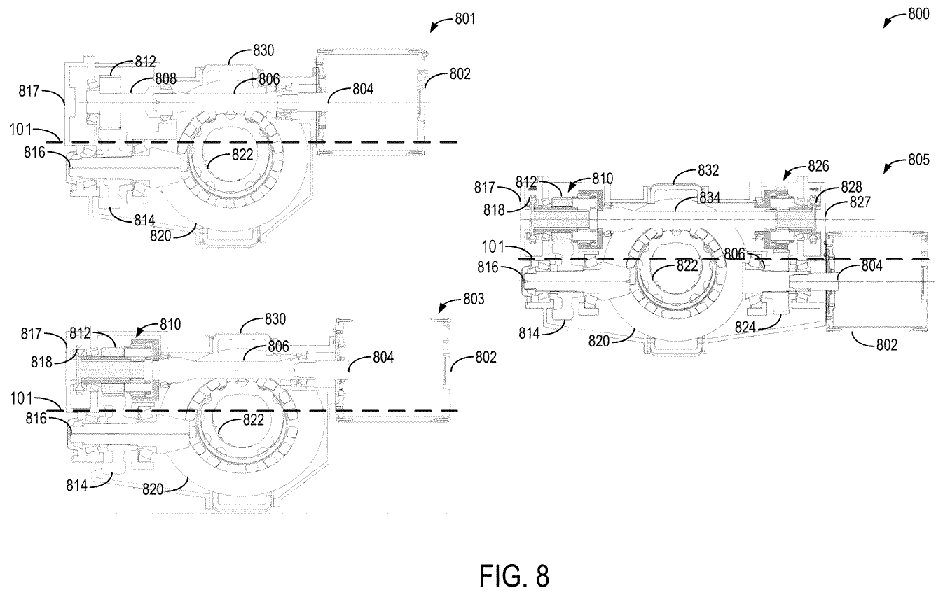

FIG. 1 depicts an electric vehicle (EV) with a first example of a multi-speed and multi-reduction electric axle. FIG. 2 is a power path diagram for the different operating gears of the exemplary multi-speed and multi-reduction electric axle, depicted in FIG. 1. FIG. 3 depicts the electric vehicle (EV) with a second example of a multi-speed and multi-reduction electric axle. FIGS. 4A and 4B are power path diagrams for the different operating gears of the exemplary multi-speed and multi-reduction electric axle, depicted in FIG. 3. FIG. 5 depicts the electric vehicle (EV) with a third example of a multi-speed and multi-reduction electric axle. FIGS. 6A-6D are power path diagrams for the different operating gears of the exemplary multi-speed and multi-reduction electric axle, depicted in FIG. 5. FIG. 7 describes a method for operating two different configurations of the modular multi-speed and multi-reduction electric axle. FIG. 8 depicts a line of electric axles based on different arrangements of the multi-speed and multi-reduction electric axle.

FIG. 1 depicts a multi-speed and multi-reduction electric axle 100 of a vehicle. The multi-speed and multi-reduction electric axle 100 generates motive power for vehicle propulsion. The multi-speed and multi-reduction electric axle will henceforth be referred to as electric axle 100. The electric axle 100 is one embodiment of the multi-speed and multi-reduction electric axle described herein. The electric axle 100 achieves two reduction ratios. The vehicle may be a light, medium, or heavy-duty vehicle. An all-electric vehicle may specifically be used due to their reduced complexity and therefore reduced points of potential component degradation. However, hybrid electric vehicle (HEV) embodiments may be employed where the vehicle includes an internal combustion engine (ICE).

The electric axle 100 does not include a synchronizer and planetary gearset system, and thus, the reduction ratios for the electric axle are fixed. Various components of the electric axle 100 are circumferentially enclosed in a housing 106 of the electric axle. The housing 106 may include at least one cover wherein the at least one cover is located on one side of the housing of the electric axle 100. Positioning the electric motor in this location allows the electric axle 100 to meet the packaging demands in a wider variety of vehicles, thereby expanding the axle's applicability. The gears described herein include teeth, and mechanical attachment between the gears involves meshing of the teeth on the gear with another associated gear.

The electric axle 100 includes an electric motor 102 on one side of the electric axle that is coupled to a first carrier 124 and a motor shaft 104. The first carrier 124 and a second carrier 118 are coupled to the housing 106 via fasteners. The electric motor 102 may include components such as a rotor and a stator that electromagnetically interact during operation to generate motive power. Further in one example, the electric motor 102 may be a motor-generator which is configured to generate electrical energy during regeneration operation. In this way, the electric motor 102 may deliver torque to the motor shaft 104 and various components of the electric axle 100 by way of the motor shaft 104.

In some embodiments, the motor may be electrically coupled to one or more energy storage device(s) (e.g., one or more traction batteries, fuel cells, capacitor(s), combinations thereof, and the like) by way of an inverter (not shown) when the motor is designed as an alternating current (AC) motor. This inverter is designed to convert direct current (DC) to alternating current (AC) and vice versa. In one use-case example, the electric motor 102 and the inverter may be three-phase devices which can achieve greater efficiency when compared to other types of devices. However, a motor and an inverter designed to operate using more than three phases have been envisioned. In other embodiments, the inverter may be omitted from the axle and a DC motor may be used in the electric axle 100 as depicted herein.

The motor shaft 104 is coupled to an input shaft 108 via splines at one end of the input shaft. The input shaft 108 extends from one side of the electric axle 100 to an opposite side of the electric axle. The input shaft 108 is coupled to an output shaft 110 via splines at the other end of the input shaft on the opposite side of the electric axle 100. A first helical gear 112 is coupled to the output shaft 110 via a spline or an alternative method, such as a spline connection, press fit, an integral single piece, or welding. The electric motor 102, the motor shaft 104, the input shaft 108, the output shaft 110, and the first helical gear 112 are located in a top half of the electric axle 100. The electric motor 102 and the motor shaft 104 are positioned on an opposite side of the electric axle 100 relative to the at least one cover.

The first helical gear 112 that is positioned in the top half of the electric axle 100 engages with a second helical gear 114 that is positioned in a bottom half of the electric axle. The second helical gear 114 is coupled to a pinion gear 116 via a spline or an alternative method, such as spline or key connections. The pinion gear 116 is positioned in the bottom half of the electric axle 100. The pinion gear 116 extends from the opposite side of the electric axle toward a center region of the electric axle where the pinion gear engages with a ring gear 120. A differential 122 is positioned in the center region of the electric axle 100, enabling the ring gear to be coupled to the differential 122, and thus, the wheels of the vehicle. In the illustrated example, the differential 122 may be a spider gear type differential, a spur gear differential, a planetary type differential, and the like.

Additionally or alternatively, the differential may have locking functionality, limited slip functionality, and the like. Although not shown, the electric axle 100 may include bearings that facilitate rotation of the motor shaft 104, the input shaft 108, the output shaft 110, the gears, and the like. The first helical gear 112, the second helical gear 114, and the pinion gear 116 are positioned on the same side of the electric axle 100 as the at least one cover, such that the first helical gear 112, the second helical gear 114 and the pinion gear 116 are positioned on one side of the electric axle 100 and the electric motor 102 and the motor shaft 104 are positioned on an opposing side of the electric axle 100.

The vehicle further includes a control system 170 with a controller 172 as shown in FIG. 1. The controller 172 may include a microcomputer with components such as a processor 174 (e.g., a microprocessor unit), input/output ports, an electronic storage medium 176 for executable programs and calibration values (e.g., a read-only memory chip, random access memory, keep alive memory, a data bus, and the like). The storage medium may be programmed with computer readable data representing instructions executable by the processor for performing the methods and control techniques described herein as well as other variants that are anticipated but not specifically listed.

The controller 172 may receive various signals from sensors 178 coupled to various regions of the vehicle and the electric axle 100. For example, the sensors 178 may include a pedal position sensor that detects a depression of an operator-actuated pedal such as an accelerator pedal and/or a brake pedal, a speed sensor at the transmission output shaft, energy storage device state of charge (SOC) sensor, clutch position sensors, and the like. Motor speed may be ascertained from the amount of power sent from the inverter to the electric machine. An input device 180 (e.g., accelerator pedal, brake pedal, drive mode selector, combinations thereof, and the like) may further provide input signals indicative of an operator's intent for vehicle control.

Upon receiving the signals from the various sensors 178 of FIG. 1, the controller 172 processes the received signals, and employs various actuators 182 of vehicle components to adjust the components based on the received signals and instructions stored on the memory of controller 172. For example, the controller 172 may receive an accelerator pedal signal indicative of an operator's request for increased vehicle acceleration. In response, the controller 172 may adjust electric motor power output and increase the power delivered from the electric motor 102 to other components of the electric axle 100. The other controllable components in the vehicle may function in a similar manner with regard to sensor signals, control commands, and actuator adjustment, for example.

An axis system 199 is provided in FIG. 1 as well as FIGS. 2-6D, for reference. The Z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples.

FIG. 2 shows the mechanical power path 200 while the multi-speed and multi-reduction electric axle depicted in FIG. 1 operates. The mechanical power path 200 unfolds as follows: mechanical power moves from the electric motor 102 to the motor shaft 104; from the motor shaft 104 to the input shaft 108; from the input shaft 108 to the output shaft 110; from the output shaft 110 to the first helical gear 112; from the first helical gear 112 to the second helical gear 114; from the second helical gear 114 to the pinion gear 116; from the pinion gear 116 to ring gear 120; from the ring gear 120 to the differential 122; and from the differential 122 to the downstream components.

In this way, the electric axle 100 achieves two reduction ratios, including a first reduction ratio R1 and a second reduction ratio R2. The first reduction ratio R1 is achieved by engaging the first helical gear 112 and the second helical gear 114 and a second reduction ratio R2 is achieved by engaging the ring gear 120 and a pinion gear 116. The first reduction ratio R1 is a quotient of a number of teeth Z2 of the second helical gear 114 and a number of teeth Z1 of the first helical gear 112. The second reduction ratio R2 is a quotient of a number of teeth ZA of the ring gear 120 and a number of teeth Z3 of the pinion gear 116. The total reduction ratio of the multi-speed and multi-reduction electric axle is a product of the first reduction ratio and the second reduction ratio.

FIG. 3 depicts a multi-speed and multi-reduction electric axle 300 of a vehicle. The multi-speed and multi-reduction electric axle 300 generates motive power for vehicle propulsion. The multi-speed and multi-reduction electric axle will henceforth be referred to as electric axle 300. The electric axle 300 is another embodiment of the multi-speed and multi-reduction electric axle described herein. The electric axle 300 achieves three reduction ratios. Elements included in electric axle 100 of FIG. 1 may not be reintroduced, for brevity. Similar to FIG. 1, the vehicle may be a light, medium, or heavy-duty vehicle. An all-electric vehicle may specifically be used due to their reduced complexity and therefore reduced points of potential component degradation. However, hybrid electric vehicle (HEV) embodiments may be employed where the vehicle includes an internal combustion engine (ICE).

The electric axle 300 includes one synchronizer and one planetary gearset system, and thus, the reduction ratio is variable. Similar to FIG. 1, various components of the electric axle 300 are circumferentially enclosed in a housing 106 of the electric axle. The housing 106 may include at least one cover wherein the at least one cover includes a first cover 310 that is located on one side of the housing of the electric axle 300. The electric axle 300 includes an electric motor 102 on one side of the electric axle that is coupled to a first carrier 124 and a motor shaft 104. The first carrier 124 and the second carrier 118 are coupled to the housing 106 via fasteners. The electric motor 102 is positioned on the same side as the second cover. The motor shaft 104 is coupled to an input shaft 108 via splines at one end of the input shaft 108.

The input shaft 108 extends from one side of the electric axle 300 to an opposite side of the electric axle 300 where the input shaft is coupled to a first annulus gear 302 of a first planetary gearset system 304 via splines at the other end of the input shaft. The first planetary gearset system 304 is located in a top half of the electric axle 300 and positioned on the same side as the first cover 310. The first planetary gearset system 304 includes the first annulus gear 302, a first set of planet gears 306, a first sun gear 312, and a first planet carrier 314. The first annulus gear 302 engages with the first set of planet gears 306, the first set of planet gears being enclosed in the first planet carrier 314 of the first planetary gearset system 304. The first set of planet gears 306 engages with the first sun gear 312 and the first annulus gear 302 of the first planetary gearset system 304.

A first synchronizer 308 is coupled to the first sun gear 312. The first synchronizer 308 is located in the top half of the electric axle 300 and positioned on the same side as the first cover 310. One synchronizer cone of the first synchronizer 308 is coupled to the first set of planet gears 306 and another synchronizer cone is coupled to the first cover 310 of the housing. The first synchronizer 308 may be axially moved to the right to enable the first synchronizer to engage with the first planet carrier 314, rendering the first planetary gearset system 304 inactive. The first synchronizer 308 may be axially moved to the left to enable the first synchronizer to engage with the first cover 310, rendering the first planetary gearset system active, respectively. The first helical gear 112 is coupled to the first planet carrier 314 via a spline or an alternative method, such as a spline or key and keyways. The electric motor 102, the motor shaft 104, the input shaft 108, the first helical gear 112, the first planetary gearset system 304, including the first annulus gear 302, the first set of planet gears 306, the first sun gear 312, and the first planet carrier 314, the first cover 310 and the first synchronizer 308 are located in a top half of the electric axle 300. The electric motor 102 and the motor shaft 104 are positioned on an opposite side of the electric axle 300 relative to the first cover 310. The first helical gear 112, the first planetary gearset system 304, and the first synchronizer are positioned on the same side as the first cover 310.

The first helical gear 112 engages with the second helical gear 114, the second helical gear 114 being located in a bottom half of the electric axle 300 and the first helical gear 112 being located in a top half of the electric axle 300. The first helical gear 112 and the second helical gear 114 are positioned on a same side of the electric axle 300 as the first cover 310. The second helical gear 114 is coupled to the pinion gear 116 via a spline or an alternative method. The pinion gear 116 is located in a bottom half of the electric axle 300. The pinion gear 116 extends from the opposite side of the electric axle 300 toward the center region of the electric axle where the pinion gear engages with the ring gear 120. The differential 122 is positioned in the center region of the electric axle 300, enabling the ring gear to be coupled to the differential 122, and thus, the wheels of the vehicle. Although not shown, the electric axle 300 may include bearings that facilitate rotation of the motor shaft 104, the input shaft 108, the gears, and the like.

The vehicle further includes a control system 170 with a controller 172 as shown in FIG. 1. The controller 172 may include a microcomputer with components such as a processor 174 (e.g., a microprocessor unit), input/output ports, an electronic storage medium 176 for executable programs and calibration values (e.g., a read-only memory chip, random access memory, keep alive memory, a data bus, and the like). The storage medium may be programmed with computer readable data representing instructions executable by the processor for performing the methods and control techniques described herein as well as other variants that are anticipated but not specifically listed. For example, the storage medium 176 may store instructions for axially adjusting a position of the first synchronizer based on signals received from sensors. FIG. 7 describes a method of operation for the electric axle 300.

The controller 172 may receive various signals from sensors 178 coupled to various regions of the vehicle and the electric axle 300. An input device 180 (e.g., accelerator pedal, brake pedal, drive mode selector, combinations thereof, and the like) may further provide input signals indicative of an operator's intent for vehicle control. Upon receiving the signals from the various sensors 178 of FIG. 1, the controller 172 processes the received signals, and employs various actuators 182 of vehicle components to adjust the components based on the received signals and instructions stored on the memory of controller 172.

FIG. 4A shows the mechanical power path 400 while the electric axle 300 depicted in FIG. 3 operates. The mechanical power path 400 unfolds as follows in response to the first synchronizer 308 axially being moved to the right: mechanical power moves from the electric motor 102 to the motor shaft 104; from the motor shaft 104 to the input shaft 108; from the input shaft 108 to the first annulus gear 302; from the first annulus gear 302 to the first set of planet gears 306; from the first set of planet gears 306 to the first sun gear 312 or from the first set of planet gears 306 to the first planet carrier 314 and from the first planet carrier to the first sun gear 312; from the first sun gear 312 to the first helical gear 112; from the first helical gear 112 to the second helical gear 114; from the second helical gear to the pinion gear 116; from the pinion gear 116 to the ring gear 120; from the ring gear 120 to the differential 122; and from the differential 122 to the downstream components.

The first synchronizer axially moved to the right side to engage the first sun gear 312 and the first planet carrier 314, rendering the first planetary gearset system inactive. The electric axle achieves the first reduction ratio R1, the second reduction ratio R2, and a third reduction ratio R3. The electric axle 300 achieves the first reduction ratio R1 by engaging the first sun gear 312 and the planet gears 306, the second reduction ratio R2 by engaging the first helical gear 112 and the second helical gear 114, and the third reduction ratio R3 by engaging the ring gear 120 and the pinion gear 116. The first reduction ratio R1 is equal to the first planetary gearset ratio. Since the first planetary gearset system is inactive, the first planetary gearset ratio is 1:1. The second reduction ratio R2 is a quotient of the number of teeth Z2 of the second helical gear 114 and the number of teeth Z1 of the first helical gear 112. The third reduction ratio R3 is the quotient of the number of teeth ZA of the ring gear 120 and the number of teeth Z3 of the pinion gear 116. The total reduction of the electric axle 300 is a product of the first reduction ratio R1, the second reduction ratio R2, and the third reduction ratio R3.

FIG. 4B shows the mechanical power path 401 while the electric axle 300 depicted in FIG. 3 operates. The mechanical power path 401 unfolds as follows in response to the first synchronizer 308 axially being moved to the left: mechanical power moves from the electric motor 102 to the motor shaft 104; from the motor shaft 104 to the input shaft 108; from the input shaft 108 to the first annulus gear 302; from the first annulus gear 302 to the first set of planet gears 306; from the first set of planet gears 306 to the first planet carrier 314; from the first planet carrier 314 to the first helical gear 112; from the first helical gear 112 to the second helical gear 114; from the second helical gear to the pinion gear 116; from the pinion gear 116 to the ring gear 120; from the ring gear 120 to the differential 122; and from the differential 122 to the downstream components.

The first synchronizer is axially moved to the left side to engage the sun gear and cover, rendering the first planetary gearset system active. The electric axle 300 achieves the first reduction ratio R1, the second reduction ratio R2, and the third reduction ratio R3. The electric axle 300 achieves the first reduction ratio R1 by engaging the first sun gear 312 and the first cover 310, the second reduction ratio R2 by engaging the first helical gear 112 and the second helical gear 114, and the third reduction ratio R3 by engaging the ring gear 120 and the pinion gear 116. The first reduction ratio R1 is equal to the first planetary gearset ratio. Since the first planetary gearset system is active, the first planetary gearset ratio is a quotient of a number of teeth of the annulus ZR1 gear and a number of teeth ZS1 of the first sun gear 312 plus one. The second reduction ratio R2 is a quotient of the number of teeth Z2 of the second helical gear 114 and the number of teeth Z1 of the first helical gear 112. The third reduction ratio R3 is the quotient of the number of teeth ZA of the ring gear 120 and the number of teeth Z3 of the pinion gear 116. The total reduction of the electric axle 300 is a product of the first reduction ratio R1, the second reduction ratio R2, and the third reduction ratio R3.

FIG. 5 depicts a multi-speed and multi-reduction electric axle 500 of a vehicle that generates motive power for vehicle propulsion. The multi-speed and multi-reduction electric axle will henceforth be referred to as electric axle 500. The electric axle 500 is another embodiment of the multi-speed and multi-reduction electric axle described herein. The electric axle 500 achieves five reduction ratios. Elements included in both electric axle 300 of FIG. 3 and electric axle 100 of FIG. 1 may not be reintroduced, for brevity. Similar to FIGS. 1 and 3, the vehicle may be a light, medium, or heavy-duty vehicle. An all-electric vehicle may specifically be used due to their reduced complexity and therefore reduced points of potential component degradation. However, hybrid electric vehicle (HEV) embodiments may be employed where the vehicle includes an internal combustion engine (ICE).

The electric axle 500 includes two synchronizers and two planetary gearset systems and thus, the reduction ratios are variable. Similar to FIGS. 1 and 3, various components of the electric axle 500 are circumferentially enclosed in a housing 524 of the electric axle. The housing 524 includes at least one cover. As such, the housing 524 includes a first cover 533 located on one side of the electric axle 500 and a second cover 513 located on an opposite side of the electric axle. The electric axle 500 includes an electric motor 502 on one side of the electric axle that is coupled to a first carrier 550 and a motor shaft 504. The first carrier 550 and a second carrier 544 are coupled to the housing 524. The motor shaft 504 is coupled to an input shaft 506 via splines at one end of the input shaft. The input shaft 506 extends from one side of the electric axle 500 to a center region of the electric axle. A third helical gear 508 is coupled to the input shaft 506 via splines or an alternative method, such as a spline and key. The electric motor 502, the motor shaft 504, the input shaft 506, and the third helical gear 508 are located in a bottom half of the electric axle 500 and positioned on the same side of the electric axle 500 as the second cover 513.

Further, the third helical gear 508 engages with external gear teeth of a second annulus gear 516 of a second planetary gearset system 518. The second planetary gearset system 518 includes the second annulus gear 516, a second set of planet gears 520, a second sun gear 512, and a second planet carrier 510. The second annulus gear 516 of the second planetary gearset system 518 is configured with both external teeth and internal teeth. The internal teeth of the second annulus gear 516 engage with a second set of planet gears 520. The second set of planet gears 520 are enclosed in the second planet carrier 510 and engage with the second sun gear 512 and the second annulus gear 516 of the second planetary gearset system 518. A second synchronizer 514 is coupled to the second sun gear 512. The second planetary gearset system 518 and the second synchronizer 514 are located in a top half of the electric axle 500 and positioned on the same side of the electric axle 500 as the second cover 513.

One synchronizer cone of the second synchronizer 514 is coupled to the second planet carrier 510 and another synchronizer cone of the second synchronizer is coupled to the second cover 513 enabling the second planetary gearset system 518 to be inactive or active, respectively. More specifically, the second synchronizer 514 may be axially moved left in order to engage the second synchronizer with the second planet carrier 510 to render the second planetary gearset system 518 inactive or right in order to engage the second synchronizer with the second cover 513 to render the second planetary gearset system active, respectively.

The second planet carrier 510 engages with an intermediate shaft 522 via splines at one end of the intermediate shaft. The intermediate shaft 522 extends from one side to an opposite side of the electric axle where the intermediate shaft is coupled to a first annulus gear 530 through splines at the other end of the intermediate shaft. The first annulus gear 530 engages with a first set of planet gears 526 of a first planetary gearset system 528. The first planetary gearset system 528 includes the first annulus gear 530, the first set of planet gears 526, a first sun gear 532, and a first planet carrier 536. The first annulus gear 530 is only configured with internal teeth. The first set of planet gears 526 of the first planetary gearset system 528 are enclosed in the first planet carrier 536. The first set of planet gears 526 engage with the first sun gear 532 and the first annulus gear 530.

A first synchronizer 534 is coupled to the first sun gear 532. The first synchronizer 534 and the first planetary gearset system 528 are located in a top half of the electric axle 500 and positioned on the same side as the first cover 533. One synchronizer cone of the first synchronizer 534 is coupled to the first planet carrier 536 and another synchronizer cone of the first synchronizer is coupled to the first cover 533. The first synchronizer 534 may be axially moved left to enable the first synchronizer to engage with the first cover 533 to render the first planetary gearset system 528 active or right to enable the first synchronizer to engage with the first planet carrier 536 to render the first planetary gearset system inactive, respectively.

A first helical gear 538 is coupled to the first planet carrier 536 via splines or an alternative method. The first helical gear 538 is coupled to a second helical gear 542. The first helical gear 538 is located in a top half of the electric axle 500 and the second helical gear 542 is located in a bottom half of the electric axle. The first helical gear 538 and the second helical gear 542 are positioned on the same side of the electric axle 500 as the first cover 533. The second helical gear 542 is coupled to a pinion gear 540 via a spline or an alternative method. The pinion gear 540 extends from the opposite side of the toward the center region of the electric axle where the pinion gear engages with the ring gear 546. The pinion gear 540 is located in a bottom half of the electric axle. A differential 548 is positioned in the center region of the electric axle 500, enabling the ring gear 546 to be coupled to the differential, and thus, the wheels of the vehicle. Although not shown, the electric axle 500 may include bearings that facilitate rotation of the motor shaft 504, the input shaft 506, the intermediate shaft 522, the gears, and the like.

The vehicle further includes a control system 170 with a controller 172 as shown in FIG. 1. The controller 172 may include a microcomputer with components such as a processor 174 (e.g., a microprocessor unit), input/output ports, an electronic storage medium 176 for executable programs and calibration values (e.g., a read-only memory chip, random access memory, keep alive memory, a data bus, and the like). The storage medium may be programmed with computer readable data representing instructions executable by the processor for performing the methods and control techniques described herein as well as other variants that are anticipated but not specifically listed. For example, the storage medium 176 may store instructions for axially adjusting a position of the first synchronizer and the second synchronizer based on signals received from sensors. FIG. 7 illustrates a method of operation of the electric axle 500.

The controller 172 may receive various signals from sensors 178 coupled to various regions of the vehicle and the electric axle 500. An input device 180 (e.g., accelerator pedal, brake pedal, drive mode selector, combinations thereof, and the like) may further provide input signals indicative of an operator's intent for vehicle control. Upon receiving the signals from the various sensors 178 of FIG. 1, the controller 172 processes the received signals, and employs various actuators 182 of vehicle components to adjust the components based on the received signals and instructions stored on the memory of controller 172.

FIG. 6A shows the mechanical power path 600 while the multi-speed and multi-reduction electric axle depicted in FIG. 5 operates. The mechanical power path 400 unfolds as follows in response to the second synchronizer 514 axially being moved to the right and the first synchronizer 534 axially being moved to the left: mechanical power moves from the electric motor 502 to the motor shaft 504; from the motor shaft 504 to the input shaft 506; from the input shaft 506 to the third helical gear 508; from the third helical gear 508 to the second annulus gear 516; from the second annulus gear 516 to the second set of planet gears 520; from the second set of planet gears 520 to the second sun gear 512; from the second sun gear 512 to the intermediate shaft 522; from the intermediate shaft 522 to the first annulus gear 530; from the first annulus gear 530 to the first set of planet gears 526; from the first set of planet gears 526 to the first planet carrier 536 and the first sun gear 532; from the first planet carrier 536 to the first sun gear 532; from the first sun gear 532 to the first helical gear 538; from the first helical gear 538 to the second helical gear 542; from the second helical gear 542 to the pinion gear 540; from the pinion gear 540 to the ring gear 546; from the ring gear 546 to the differential 548; and from the differential 548 to the downstream components.

The second synchronizer 514 is axially moved to the right side (e.g., toward the second cover 513) to engage the second sun gear 512 and the second cover 513, rendering the second planetary gearset system 518 active. The first synchronizer 534 is axially moved to the left side (e.g., toward the first cover 533) to engage the first sun gear 532 and the first cover 533, rendering the first planetary gearset system 528 active. The electric axle 500 achieves a first reduction ratio R1 by engaging the third helical gear 508 and external teeth of the second annulus gear 516, a second reduction ratio R2 by engaging the second sun gear 512 and the second cover 513, a third reduction ratio R3 by engaging the first sun gear 532 and the first cover 533, a fourth reduction ratio R4 by engaging the first helical gear 538 and the second helical gear 542, and a fifth reduction ratio R5 by engaging the ring gear 546 and the pinion gear 540.

The first reduction ratio R1 is a quotient of a number of teeth Z1 of the third helical gear 508 and a number of external teeth Z2 of the second annulus gear 516. The second reduction ratio R2 is equal to the second planetary gearset ratio. Since the second planetary gearset system 518 is active, the second planetary gearset ratio is a quotient of a number of internal teeth ZR1 of the second annulus gear 516 and a number of teeth ZS1 of the second sun gear 512 plus one. The third reduction ratio R3 is equal to the first planetary gearset ratio. Since the first planetary gearset system 528 is active, the first planetary gearset ratio is a quotient of a number of internal teeth ZR2 of the first annulus gear and a number of teeth ZS2 of the first sun gear 532 plus one. The fourth reduction ratio R4 is a quotient of the number of teeth ZA of the second helical gear 542 and the number of teeth Z3 of the first helical gear 538. The fifth reduction ratio R5 is the quotient of the number of teeth Z6 of the ring gear 546 and the number of teeth Z5 of the pinion gear 540. The total reduction of the electric axle 500 is a product of the first reduction ratio R1, the second reduction ratio R2, the third reduction ratio R3, the fourth reduction ratio R4, and the fifth reduction ratio R5.

FIG. 6B shows the mechanical power path 601 while the multi-speed and multi-reduction electric axle depicted in FIG. 5 operates. The mechanical power path 400 unfolds as follows in response to the second synchronizer 514 axially being moved to the right and the first synchronizer 534 axially being moved to the right: mechanical power moves from the electric motor 502 to the motor shaft 504; from the motor shaft 504 to the input shaft 506; from the input shaft 506 to the third helical gear 508; from the third helical gear 508 to the second annulus gear 516; from the second annulus gear 516 to the first set of planet gears 520; from the first set of planet gears 520 to the second sun gear 512; from the second sun gear 512 to the intermediate shaft 522; from the intermediate shaft 522 to the first annulus gear 530; from the first annulus gear 530 to the first set of planet gears 526; from the first set of planet gears 526 to the first sun gear 532 and the first planet carrier 536; from the first planet carrier 536 to the first sun gear 532; from the first sun gear 532 to the first helical gear 538; from the first helical gear 538 to the second helical gear 542; from the second helical gear 542 to the pinion gear 540; from the pinion gear 540 to the ring gear 546; from the ring gear 546 to the differential 548; and from the differential 548 to the downstream components.

The second synchronizer 514 is axially moved to the right side (e.g., toward the second cover 513) to engage the second sun gear 512 and the second cover 513, rendering the second planetary gearset system 518 active. The first synchronizer 534 is axially moved to the right side (e.g., toward the first planet carrier 536) to engage the first sun gear 532 and the first planet carrier 536, rendering the first planetary gearset system 528 inactive. The electric axle 500 achieves the first reduction ratio R1, the second reduction ratio R2, the third reduction ratio R3, the fourth reduction ratio R4, and the fifth reduction ratio R5. The electric axle 500 achieves a first reduction ratio R1 by engaging the third helical gear 508 and external teeth of the second annulus gear 516, a second reduction ratio R2 by engaging the second sun gear 512 and the second cover 513, a third reduction ratio R3 by engaging the first sun gear 532 and the first planet carrier 536, a fourth reduction ratio R4 by engaging the first helical gear 538 and the second helical gear 542, and a fifth reduction ratio R5 by engaging the ring gear 546 and the pinion gear 540.

The first reduction ratio R1 is a quotient of a number of teeth Z1 of the third helical gear 508 and a number of external teeth Z2 of the second annulus gear 516. The second reduction ratio R2 is equal to the second planetary gearset ratio. Since the second planetary gearset system 518 is active, the second planetary gearset ratio is a quotient of a number of internal teeth ZR1 of the second annulus gear 516 and a number of teeth ZS1 of the second sun gear 512 plus one. The third reduction ratio R3 is equal to the first planetary gearset ratio. Since the first planetary gearset system 528 is inactive, the first planetary gearset ratio is 1:1. The fourth reduction ratio R4 is a quotient of the number of teeth ZA of the second helical gear 542 and the number of teeth Z3 of the first helical gear 538. The fifth reduction ratio R5 is the quotient of the number of teeth Z6 of the ring gear 546 and the number of teeth Z5 of the pinion gear 540. The total reduction of the electric axle 500 is a product of the first reduction ratio R1, the second reduction ratio R2, the third reduction ratio R3, the fourth reduction ratio R4, and the fifth reduction ratio R5.

FIG. 6C shows the mechanical power path 603 while the multi-speed and multi-reduction electric axle depicted in FIG. 5 operates. The mechanical power path 400 unfolds as follows in response to the second synchronizer 514 axially being moved to the left and the first synchronizer 534 axially being moved to the left: mechanical power moves from the electric motor 502 to the motor shaft 504; from the motor shaft 504 to the input shaft 506; from the input shaft 506 to the third helical gear 508; from the third helical gear 508 to the second annulus gear 516; from the second annulus gear 516 to the second set of planet gears 520; from the second set of planet gears 520 to the second planet carrier 510 and the second sun gear 512; from the second sun gear 512 to the second planet carrier 510; from the second planet carrier 510 to the intermediate shaft 522; from the intermediate shaft 522 to the first annulus gear 530; from the first annulus gear 530 to the first set of planet gears 526; from the first set of planet gears 526 to the first planet carrier 536 and the first sun gear 532; from the first planet carrier 536 to the first sun gear 532; from the first sun gear 532 to the first helical gear 538; from the first helical gear 538 to the second helical gear 542; from the second helical gear 542 to the pinion gear 540; from the pinion gear 540 to the ring gear 546; from the ring gear 546 to the differential 548; and from the differential 548 to the downstream components.

The second synchronizer 514 is axially moved to the left side (e.g., toward the second planet carrier 510) to engage the second sun gear 512 and the second planet carrier 510, rendering the second planetary gearset system 518 inactive. The first synchronizer 534 is axially moved to the left side (e.g., toward the first cover 533) to engage the first sun gear 532 and the first cover 533, rendering the first planetary gearset system 528 active. The electric axle 500 achieves the first reduction ratio R1, the second reduction ratio R2, the third reduction ratio R3, the fourth reduction ratio R4, and the fifth reduction ratio R5. The electric axle 500 achieves a first reduction ratio R1 by engaging the third helical gear 508 and external teeth of the second annulus gear 516, a second reduction ratio R2 by engaging the second sun gear 512 and the second planet carrier 510, a third reduction ratio R3 by engaging the first sun gear 532 and the first planet carrier 536, a fourth reduction ratio R4 by engaging the first helical gear 538 and the second helical gear 542, and a fifth reduction ratio R5 by engaging the ring gear 546 and the pinion gear 540.

The first reduction ratio R1 is a quotient of a number of teeth Z1 of the third helical gear 508 and a number of external teeth Z2 of the second annulus gear 516. The second reduction ratio R2 is equal to the second planetary gearset ratio. Since the second planetary gearset system 518 is inactive, the second planetary gearset ratio is 1:1. The third reduction ratio R3 is equal to the first planetary gearset ratio. Since the first planetary gearset system 528 is active, the first planetary gearset ratio is a quotient of a number of internal teeth ZR2 of the first annulus gear 530 and a number of teeth ZS2 of the first sun gear 532 plus one. The fourth reduction ratio R4 is a quotient of the number of teeth ZA of the second helical gear 542 and the number of teeth Z3 of the first helical gear 538. The fifth reduction ratio R5 is the quotient of the number of teeth Z6 of the ring gear 546 and the number of teeth Z5 of the pinion gear 540. The total reduction of the electric axle 500 is a product of the first reduction ratio R1, the second reduction ratio R2, the third reduction ratio R3, the fourth reduction ratio R4, and the fifth reduction ratio R5.

FIG. 6D shows the mechanical power path 605 while the multi-speed and multi-reduction electric axle depicted in FIG. 5 operates. The mechanical power path 400 unfolds as follows in response to the second synchronizer 514 axially being moved to the left and the first synchronizer 534 axially being moved to the right: mechanical power moves from the electric motor 502 to the motor shaft 504; from the motor shaft 504 to the input shaft 506; from the input shaft 506 to the third helical gear 508; from the third helical gear 508 to the second annulus gear 516; from the second annulus gear 516 to the second set of planet gears 520; from the second set of planet gears 520 to the second planet carrier 510 and the second sun gear 512; from the second sun gear 512 to the second planet carrier 510; from the second planet carrier 510 to the intermediate shaft 522; from the intermediate shaft 522 to the first annulus gear 530; from the first annulus gear 530 to the first set of planet gears 526; from the first set of planet gears 526 to the first planet carrier 536; from the first planet carrier 536 to the first helical gear 538; from the first helical gear 538 to the second helical gear 542; from the second helical gear 542 to the pinion gear 540; from the pinion gear 540 to the ring gear 546; from the ring gear 546 to the differential 548; and from the differential 548 to the downstream components.

The second synchronizer 514 is axially moved to the left side (e.g., toward the second planet carrier 510) to engage the second sun gear 512 and the second planet carrier 510, rendering the second planetary gearset system 518 inactive. The first synchronizer is axially moved to the right side (e.g., toward the first planet carrier 536) to engage the first sun gear 532 and the first planet carrier 536, rendering the first planetary gearset system 528 inactive. The electric axle 500 achieves a first reduction ratio R1 by engaging the third helical gear 508 and external teeth of the second annulus gear 516, a second reduction ratio R2 by engaging the second sun gear 512 and the second planet carrier 510, a third reduction ratio R3 by engaging the first sun gear 532 and the first planet carrier 536, a fourth reduction ratio R4 by engaging the first helical gear 538 and the second helical gear 542, and a fifth reduction ratio R5 by engaging the ring gear 546 and the pinion gear 540.

The first reduction ratio R1 is a quotient of a number of teeth Z1 of the third helical gear 508 and a number of external teeth Z2 of the second annulus gear 516. The second reduction ratio R2 is equal to the second planetary gearset ratio. Since the second planetary gearset system 518 is inactive, the second planetary gearset ratio is 1:1. The third reduction ratio R3 is equal to the first planetary gearset ratio. Since the first planetary gearset system 528 is inactive, the first planetary gearset ratio is 1:1. The fourth reduction ratio R4 is a quotient of the number of teeth ZA of the second helical gear 542 and the number of teeth Z3 of the first helical gear 538. The fifth reduction ratio R5 is the quotient of the number of teeth Z6 of the ring gear 546 and the number of teeth Z5 of the pinion gear 540. The total reduction of the electric axle 500 is a product of the first reduction ratio R1, the second reduction ratio R2, the third reduction ratio R3, the fourth reduction ratio R4, and the fifth reduction ratio R5.

It may be understood that the electric axle systems depicted in FIGS. 1, 3, and 5 are exemplary and deviations from the example electric axle systems do not depart from the scope of the present disclosure. For instance, the electric axle systems may include fewer or more components so long as each of the electric axle systems are achievable based on the adaptability of one electric axle system.

FIG. 7 shows an example method 700 for operation of an electric axle system, such as the multi-speed and multi-reduction electric axles described above in reference to FIGS. 3 and 5. Method 700 may be carried out by a controller, and stored as instructions in memory therein. Instructions for carrying out method 700 may be executed by the controller in conjunction with signals received from sensors of the vehicle, such as the sensors described above with reference to FIG. 1. The controller may employ actuators of the system (e.g. the synchronizers) to adjust operation of the system, according to the method described below.

At 702, the method 700 includes axially moving a respective synchronizer. To achieve different reduction ratios, the respective synchronizer may be axially moved. The respective synchronizer may be axially moved toward one of a planet carrier of a respective planetary gearset system or a cover of the housing via an actuator in response to a sensor receiving signals indicating that axial movement of the respective synchronizer is demanded. A different reduction ratio is achieved when axially moving the synchronizer toward the planet carrier compared to the reduction ratio achieved by moving the synchronizer toward the cover of the housing. The direction in which the respective synchronizer changes based on the configuration of the multi-speed and multi-reduction electric axle.

For example, the respective synchronizer is positioned on a left side of the electric axle system depicted in FIGS. 3 and 5. Accordingly, the cover of the housing is positioned left of the synchronizer and the planet carrier of the respective planetary gearset system is positioned right of the synchronizer. Therefore, the respective synchronizer is axially moved to the left toward the cover and axially moved to the right toward the planet carrier as demanded. In another example, the respective synchronizer is positioned on a right side of the electric axle system as depicted in FIG. 5. As such, the cover is positioned right of the synchronizer and the planet carrier is positioned left of the synchronizer. Thus, the respective synchronizer is axially moved to the right toward the cover and axially moved to the left toward the planet carrier.

At 704, the method 700 includes engaging a sun gear of the respective planetary gearset system with one of the planet carrier or the cover to achieve different reduction ratios of the planetary gearset system. The respective planetary gearset system is rendered inactive in response to axially moving the respective synchronizer toward the planet carrier and engaging the sun gear and planet carrier of the respective planetary gearset system to achieve one reduction ratio. In contrast, the respective planetary gearset system is rendered active in response to axially moving the respective synchronizer toward the cover and engaging the sun gear and the cover to achieve another reduction ratio. The reduction ratio achieved while the planetary gearset system is active is different than the reduction ratio achieved while the planetary gearset system is inactive.

In one example, for electric axle system (e.g., FIGS. 3 and 5) wherein a first planetary gearset system is located on a left side of the housing of the electric axle system, the first planetary gearset system is rendered inactive in response to a first synchronizer being axially moved to the right to engage a first sun gear and a first planet carrier of the first planetary gearset system and active in response to the first synchronizer being axially moved to the left to engage the first sun gear and a first cover of the housing. In another example, for the electric axle system depicted in FIG. 5 wherein a second planetary gearset system is located on a right side of the housing of the electric axle system, the second planetary gearset system is rendered inactive in response to a second synchronizer being axially moved to the left to engage a second sun gear and a second planet carrier and active in response to the second synchronizer being axially moved to the right to engage the second sun gear and a second cover. The method 700 then ends.

FIG. 8 illustrates a line of electric axles 800 that comprise different arrangements of a multi-speed and multi-reduction electric axle. The multi-speed and multi-reduction electric axle may be embodiments of the electric axles 100, 300, and 500 depicted in FIGS. 1, 3, and 5. In general, the multi-speed and multi-reduction electric axle may include a housing with at least one cover that circumferentially encloses the multi-speed and multi-reduction electric axle system, an electric motor rotationally coupled to a motor shaft, the motor shaft being coupled to an input shaft via splines and a carrier, no more than two planetary gearset systems, each planetary gearset system comprising an annulus gear, a sun gear, planet gears, and a planet carrier, no more than two synchronizers wherein each synchronizer is coupled to a respective sun gear and axially moveable to engage the sun gear with one of the at least one cover of the housing or planet carrier of a respective planetary gearset system, at least two helical gears wherein at least one helical gear is positioned above another helical gear enabling the at least two helical gears to engage with each other, and a pinion gear that is coupled to one helical gear via a spline and engages with a ring gear, the ring gear being coupled to a differential.

The line of electric axles 800 may include a first transmission 801 with a first arrangement, a second transmission 803 with a second arrangement, and a third transmission 805 with a third arrangement of the multi-speed and multi-reduction electric axle. Each of the first transmission 801, the second transmission 803, and the third transmission 805 includes a housing comprising at least a first cover 817 positioned on one side of the respective transmission that circumferentially encloses the respective transmission, the position of the first cover being the same for each of the first transmission, the second transmission, and the third transmission. The first transmission 801, the second transmission 803, and the third transmission 805 further include an electric motor 802 rotationally coupled to a motor shaft 804, the motor shaft being coupled to an input shaft 806 via splines and a carrier. The electric motor 802 is positioned on the opposite side of the respective transmission relative to the first cover 817.

The first transmission 801, the second transmission 803, and the third transmission 805 further include a pair of helical gears positioned on the same side of the respective transmission as the first cover 817. The pair of helical gears include a first helical gear 812 positioned in a top half and a second helical gear 814 positioned in a bottom half of the respective transmission that engage with each other and neither of the first helical gear and the second helical gear is coupled to the input shaft 806. The first transmission 801, the second transmission 803, and the third transmission 805 also include a pinion gear 816 positioned on the same side of the respective transmission as the first cover 817 and coupled to the second helical gear 814 via a spline. The pinion gear 816 engages with a ring gear 820, the ring gear being coupled to a differential 822 in a center region of the respective transmission.

The first transmission 801, the second transmission 803, and the third transmission 805 differ from each other based on a number of covers, a number of planetary gearset systems, a number of synchronizers, and a number of helical gears included in the respective transmission. Additionally, the first transmission 801, the second transmission 803, and the third transmission 805 differ from each other based on components that are coupled to the overlapping components included in each transmission.

More specifically, the first transmission 801 and the second transmission 803 include a first housing 830 that is that same for both of the first transmission and the second transmission despite the arrangement of the first transmission and the second transmission being different from each other. The third transmission 805 has a different housing compared due to the motor being positioned differently (e.g., in a bottom of the third transmission) and the third transmission being configured with an additional planetary gearset, an additional synchronizer, and cover compared to the first transmission 801 and the second transmission 803.

Accordingly, the electric motor 802 is positioned in the top half of the first transmission 801 and the second transmission 803. In contrast to the second transmission 803 and the third transmission 805, the first transmission 801 further includes the input shaft 806 being coupled to an output shaft 808 and the first helical gear 812 being coupled to the output shaft via splines on the same side of the respective transmission as the first cover 817. The input shaft 806 of the second transmission 803 and the third transmission 805 are not coupled to the output shaft 808. Similarly, the first helical gear 812 of the second transmission 803 and the third transmission 805 is not coupled to the output shaft via splines on the same side of the respective transmission as the first cover. Rather, the input shaft 806 and the first helical gear 812 are coupled to different components in the second transmission 803 and third transmission 805. Neither of the second transmission 803 and the third transmission 805 include the output shaft 808 in their respective arrangements.

In contrast to the first transmission 801, the second transmission 803 and the third transmission 805 further include a first planetary gearset system 810 comprising a first annulus gear, a first sun gear, a first planet carrier, and a first set of planet gears and a first synchronizer 818. Compared to the second transmission 803 and the third transmission 805, the first transmission 801 does not include any planetary gears set systems or any synchronizers.

The first planetary gearset system 810 is located in a top half and positioned on the same side as the first cover 817 of the respective transmission. The first synchronizer 818 is located in a top half and positioned on the same side as the first cover 817 of the respective transmission and coupled to the first sun gear of the first planetary gearset system 810. The first helical gear 812 is coupled to the first planet carrier via splines in both of the second transmission 803 and the third transmission 805. As such, the first helical gear 812 is not coupled to the first planet carrier via splines in the first transmission 801 given that the first transmission does not include any planetary gearset systems. In contrast to the first transmission 801 and the third transmission 805, the second transmission 803 further includes the input shaft 806 being coupled to the first annulus gear of the first planetary gearset system 810 via splines. The input shaft 806 is not coupled to the first annulus gear via splines in either of the first transmission 801 and the third transmission 805.

Further, in contrast to the first transmission 801 and the second transmission 803, the third transmission 805 includes the input shaft 806 being coupled to a third helical gear 824 that is positioned on the opposite side of the third transmission relative to the first cover 817 and located in a bottom half of the third transmission. Neither of the first transmission 801 and the second transmission 803 include the third helical gear 824. Thus, the first transmission 801 and the second transmission 803 are configured such that the input shaft 806 is not coupled to the third helical gear 824 positioned on the opposite side of the respective transmission relative to the first cover 817 and not located in a bottom half of the respective transmission.

The third transmission 805 further includes a second housing 832 comprising the first cover 817 and a second cover 827 that is positioned on another side of the third transmission relative to the first cover. The third transmission 805 also includes the electric motor 802 being located in the bottom half of the third transmission and the third helical gear being engaged with external teeth of a second annulus gear of a second planetary gearset system 826. Neither of the first transmission 801 and the second transmission 803 include the second cover 827, the electric motor 802 being located in the bottom half of the respective transmission, or the second planetary gearset system 826. As such, the first transmission 801 and the second transmission 803 are configured such that the third helical gear 824 is not engaged with external teeth of the second annulus gear of the second planetary gearset system 826 due to neither of first transmission and the second transmission being configured with the third helical gear 824 and the second planetary gearset system 826.

The second planetary gearset system 826 is located in the top half and positioned on the same side as the second cover 827 of the third transmission. The second planetary gearset system 826 comprises a second annulus gear, a second set of planet gears, a second planet carrier, and a second sun gear. The third transmission 805 further includes a second synchronizer 828 coupled to the second sun gear of the second planetary gearset system 826, the second planet carrier of the second planetary gearset system engaging with an intermediate shaft 834 via splines, and the intermediate shaft 834 being coupled to the first annulus gear of the first planetary gearset system 810 via splines.

Neither of the first transmission 801 and the second transmission 803 includes the second synchronizer 828 or the intermediate shaft 834. Accordingly, the first transmission 801 and the second transmission 803 are configured such that the second synchronizer 828 is not coupled to the second sun gear of the second planetary gearset system 826, the second planet carrier of the second planetary gearset system does not engage with the intermediate shaft 834 via splines, and the intermediate shaft 834 is not coupled to the first annulus gear of the first planetary gearset system 810 due to the first transmission and the second transmission not being configured with the second synchronizer 828 and the intermediate shaft 834 and the first transmission not being configured with the first planetary gearset system 810.

The technical effect of a multi-speed and multi-reduction electric axle system with an adaptable configuration that changes based on a number of synchronizers and a number of synchronizers integrated within the multi-speed and multi-reduction electric axle system is that that multiple speed and reduction capabilities are possible while achieving a demanded level of compactness of the electric axle system.

The disclosure also provides support for a multi-speed and multi-reduction electric axle system, comprising: a housing with at least one cover that circumferentially encloses the multi-speed and multi-reduction electric axle system, an electric motor rotationally coupled to a motor shaft, the motor shaft being coupled to an input shaft via splines and a carrier, no more than two planetary gearset systems, each planetary gearset system comprising an annulus gear, a sun gear, planet gears, and a planet carrier, no more than two synchronizers wherein each synchronizer is coupled to a respective sun gear and axially moveable to engage the sun gear with one of the at least one cover of the housing or planet carrier of a respective planetary gearset system, at least two helical gears wherein at least one helical gear is positioned above another helical gear enabling the at least two helical gears to engage with each other, and a pinion gear that is coupled to one helical gear via a spline and engages with a ring gear, the ring gear being coupled to a differential.

In a first example of the system, the at least one cover comprises a first cover located on one side of the multi-speed and multi-reduction electric axle system, the first cover being located in a top half of the multi-speed and multi-reduction electric axle system. In a second example of the system, optionally including the first example, the at least two helical gears includes a first helical gear and a second helical gear that engages with the first helical gear and is coupled to the pinion gear, the first helical gear being located on a same side as the first cover and in the top half of the multi-speed and multi-reduction electric axle system and the second helical gear being located on the same side as the first cover and in a bottom half of the multi-speed and multi-reduction electric axle system. In a third example of the system, optionally including one or both of the first and second examples, the electric motor, the motor shaft, and one end of the input shaft is located on an opposite side of the multi-speed and multi-reduction electric axle system relative to the first cover and in the top half of the multi-speed and multi-reduction electric axle system.

In a fourth example of the system, optionally including one or more or each of the first through third examples, the no more than two planetary gearset systems includes a first planetary gearset system located on a same side as the first cover and in the top half of the multi-speed and multi-reduction electric axle system, and comprising a first sun gear, a first set of planet gears, a first annulus gear, and a first planet carrier, and wherein the no more than two synchronizers includes a first synchronizer located on the same side as the first cover and in the top half of the multi-speed and multi-reduction electric axle system. In a fifth example of the system, optionally including one or more or each of the first through fourth examples, the input shaft is coupled to an output shaft coupled to the first helical gear, the input shaft is coupled to the first annulus gear of the first planetary gearset system, and the first planet carrier is coupled to the first helical gear of the first planetary gearset system.

In a sixth example of the system, optionally including one or more or each of the first through fifth examples, the electric motor, the motor shaft, and the input shaft is located on an opposite side of the multi-speed and multi-reduction electric axle system relative to the first cover and in a bottom half of the multi-speed and multi-reduction electric axle system. In a seventh example of the system, optionally including one or more or each of the first through sixth examples, the at least two helical gears further include a third helical gear located on the same side as a second cover and in the bottom half of the multi-speed and multi-reduction electric axle system and coupled to the input shaft via splines. In an eighth example of the system, optionally including one or more or each of the first through seventh examples, the no more than two planetary gearset systems further includes a second planetary gearset system located on the same side as the second cover and in the top half of the multi-speed and multi-reduction electric axle system, and comprising a second sun gear, a second set of planet gears, a second annulus gear, and a second planet carrier.

In a ninth example of the system, optionally including one or more or each of the first through eighth examples, the no more than two synchronizers include a second synchronizer located on the same side as the second cover and in the top half of the multi-speed and multi-reduction electric axle system. In a tenth example of the system, optionally including one or more or each of the first through ninth examples, the third helical gear engages with internal teeth of the second annulus gear of the second planetary gearset system, the second planet carrier engages with an intermediate shaft, and the intermediate shaft is coupled to the first annulus gear of the first planetary gearset system.

The disclosure also provides support for a method for operation of a modular multi-speed and multi-reduction electric axle, comprising: axially moving a respective synchronizer toward one of a planet carrier of a respective planetary gearset system or a cover of a housing, and engaging a sun gear of the respective planetary gearset system with one of the planet carrier or the cover to achieve different reduction ratios of the respective planetary gearset system. In a first example of the method, the respective planetary gearset system is rendered inactive in response to axially moving the respective synchronizer toward the planet carrier and engaging the sun gear and planet carrier of the respective planetary gearset system and the respective planetary gearset system is rendered active in response to axially moving the respective synchronizer toward the cover and engaging the sun gear and the cover.

The disclosure also provides support for a line of axle systems, comprising: a first transmission, a second transmission, and a third transmission, each of the first transmission, the second transmission, and the third transmission comprising: a housing comprising at least a first cover positioned on one side of a respective transmission that circumferentially encloses the respective transmission, a position of a first cover being the same for each of the first transmission, the second transmission, and the third transmission, an electric motor rotationally coupled to a motor shaft, the motor shaft being coupled to an input shaft via splines and a carrier and the electric motor being positioned on an opposite side of the respective transmission relative to the first cover, a pair of helical gears positioned on a same side of the respective transmission as the first cover and comprising a first helical gear positioned in a top half and a second helical gear positioned in a bottom half of the respective transmission that engage with each other and neither of the first helical gear and the second helical gear is coupled to the input shaft, and a pinion gear positioned on the same side of the respective transmission as the first cover and coupled to the second helical gear via a spline and engages with a ring gear, the ring gear being coupled to a differential in a center region of the respective transmission.

In a first example of the system, the first transmission and the second transmission further comprises: the electric motor being positioned in the top half of the respective transmission, the electric motor not being positioned in the bottom half of the respective transmission, the housing not comprising a second cover positioned on another side of the respective transmission relative to the first cover, wherein a third helical gear is not engaged with external teeth of a second annulus gear of a second planetary gearset system and the second planetary gearset system is not located in the top half and positioned on the same side as the second cover of the respective transmission, wherein a second synchronizer is not coupled to a second sun gear of the second planetary gearset system and a second planet carrier does not engage with an intermediate shaft via splines, and wherein the intermediate shaft is not coupled to a first annulus gear of a first planetary gearset system via splines. In a second example of the system, optionally including the first example, the first transmission further comprises: the input shaft being coupled to an output shaft, the first helical gear being coupled to the output shaft via splines on the same side of the respective transmission as the first cover, the input shaft not being coupled to the first annulus gear of the first planetary gearset system located in the top half and positioned on the same side as the first cover, wherein the first helical gear is not coupled to a first planet carrier of the first planetary gearset system via splines, the input shaft not being coupled to the third helical gear positioned on the opposite side of the respective transmission relative to the first cover and located in the bottom half of the respective transmission, wherein a first synchronizer is not located in the top half and positioned on the same side as the first cover of the respective transmission and coupled to a first sun gear of the first planetary gearset system.

In a third example of the system, optionally including one or both of the first and second examples, the second transmission and the third transmission further comprise: the input shaft not being coupled to the output shaft and the first helical gear not being coupled to the output shaft via splines on the same side of the respective transmission as the first cover, the first planetary gearset system being located in the top half and positioned on the same side as the first cover of the respective transmission, the first planetary gearset system comprising the first annulus gear, the first sun gear, the first planet carrier, and a first set of planet gears, the first synchronizer located in the top half and positioned on the same side as the first cover of the respective transmission and coupled to the first sun gear of the first planetary gearset system, and the first helical gear being coupled to the first planet carrier via splines.

In a fourth example of the system, optionally including one or more or each of the first through third examples, the second transmission includes the input shaft being coupled to the first annulus gear of the first planetary gearset system via splines and not being coupled to the third helical gear positioned on the opposite side of the respective relative to the first cover and located in the bottom half of the respective transmission, and the third transmission includes the input shaft being coupled to the third helical gear.

In a fifth example of the system, optionally including one or more or each of the first through fourth examples, the third transmission further comprises: the housing further comprises the second cover positioned on another side of the respective transmission, the electric motor being located in the bottom half of the respective transmission, the electric motor not being located in the top half of the respective transmission, the third helical gear being engaged with external teeth of the second annulus gear of the second planetary gearset system, the second planetary gearset system being located in the top half, positioned on the same side as the second cover of the respective transmission, and comprising the second annulus gear, a second set of planet gears, the second planet carrier, and the second sun gear, and the second synchronizer coupled to the second sun gear of the second planetary gearset system. In a sixth example of the system, optionally including one or more or each of the first through fifth examples, the third transmission further comprises: the second planet carrier engaging with the intermediate shaft via splines, and the intermediate shaft being coupled to the first annulus gear of the first planetary gearset system via splines.

FIGS. 1-6D and 8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another.

Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Features described as axial may be approximately parallel with an axis referenced unless otherwise specified. Features described as counter-axial may be approximately perpendicular to the axis referenced unless otherwise specified. Features described as radial may be circumferentially around or extend in a radially outward from an axis, such as the axis referenced, or a component or feature described prior as being radial to a referenced axis, unless otherwise specified.

Note that the example control and estimation routines included herein can be used with various powertrain, electric drive, and/or vehicle system configurations. The control methods and routines disclosed herein may be stored as executable instructions in non-transitory memory and may be carried out by the control system including the controller in combination with the various sensors, actuators, and other transmission and/or vehicle hardware in combination with the electronic controller. As such, the described actions, operations, and/or functions may graphically represent code to be programmed into non-transitory memory of the computer readable storage medium in the vehicle and/or driveline control system. The various actions, operations, and/or functions illustrated may be performed in the sequence illustrated, in parallel, or in some cases omitted. Likewise, the order of processing is not necessarily required to achieve the features and advantages of the examples described herein, but is provided for ease of illustration and description. One or more of the illustrated actions, operations and/or functions may be repeatedly performed depending on the particular strategy being used. One or more of the method steps described herein may be omitted if desired.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A multi-speed and multi-reduction electric axle system, comprising:
a housing with at least one cover that circumferentially encloses a transmission assembly of the multi-speed and multi-reduction electric axle system;
an electric motor rotationally coupled to a motor shaft, the motor shaft being coupled to an input shaft via splines and a carrier;
no more than two planetary gearset systems, each planetary gearset system comprising an annulus gear, a sun gear, planet gears, and a planet carrier;
no more than two synchronizers wherein each synchronizer is coupled to a respective sun gear and axially moveable to engage the sun gear with one of the at least one cover of the housing or planet carrier of a respective planetary gearset system;
at least two helical gears, wherein at least one helical gear of the at least two helical gears is positioned above another helical gear of the at least two helical gears enabling the at least two helical gears to engage with each other; and
a pinion gear that is coupled to one helical gear via a spline and engages with a ring gear, the ring gear being coupled to a differential,
wherein the at least one cover comprises a first cover located on one side of the multi-speed and multi-reduction electric axle system, the first cover being located in a top half of the multi-speed and multi-reduction electric axle system,
wherein the at least two helical gears includes a first helical gear and a second helical gear that engages with the first helical gear and is coupled to the pinion gear, the first helical gear being located on a same side as the first cover and in the top half of the multi-speed and multi-reduction electric axle system and the second helical gear being located on the same side as the first cover and in a bottom half of the multi-speed and multi-reduction electric axle system, and
wherein the at least two helical gears further include a third helical gear located on the same side as a second cover and in the bottom half of the multi-speed and multi-reduction electric axle system and coupled to the input shaft via splines.

2-3. (canceled)

4. The multi-speed and multi-reduction electric axle system of claim 1, wherein the electric motor, the motor shaft, and one end of the input shaft is located on an opposite side of the multi-speed and multi-reduction electric axle system relative to the first cover and in the top half of the multi-speed and multi-reduction electric axle system.

5. The multi-speed and multi-reduction electric axle system of claim 1, wherein the no more than two planetary gearset systems includes a first planetary gearset system located on a same side as the first cover and in the top half of the multi-speed and multi-reduction electric axle system, and comprising a first sun gear, a first set of planet gears, a first annulus gear, and a first planet carrier, and wherein the no more than two synchronizers includes a first synchronizer located on the same side as the first cover and in the top half of the multi-speed and multi-reduction electric axle system.

6. The multi-speed and multi-reduction electric axle system of claim 5, wherein the input shaft is coupled to the first annulus gear of the first planetary gearset system, and the first planet carrier is coupled to the first helical gear of the first planetary gearset system.

7. The multi-speed and multi-reduction electric axle system of claim 1, wherein the electric motor, the motor shaft, and the input shaft is located on an opposite side of the multi-speed and multi-reduction electric axle system relative to the first cover and in a bottom half of the multi-speed and multi-reduction electric axle system.

8. (canceled)

9. The multi-speed and multi-reduction electric axle system of claim 1, wherein the no more than two planetary gearset systems further includes a second planetary gearset system located on the same side as the second cover and in the top half of the multi-speed and multi-reduction electric axle system, and comprising a second sun gear, a second set of planet gears, a second annulus gear, and a second planet carrier.

10. The multi-speed and multi-reduction electric axle system of claim 9, wherein the no more than two synchronizers include a second synchronizer located on the same side as the second cover and in the top half of the multi-speed and multi-reduction electric axle system.

11. The multi-speed and multi-reduction electric axle system of claim 9, wherein the third helical gear engages with internal teeth of the second annulus gear of the second planetary gearset system, the second planet carrier engages with an intermediate shaft, and the intermediate shaft is coupled to the first annulus gear of the first planetary gearset system.

12. A method for operation of a modular multi-speed and multi-reduction electric axle, comprising:
axially moving a respective synchronizer toward one of a planet carrier of a respective planetary gearset system or a cover of a housing; and
engaging a sun gear of the respective planetary gearset system with one of the planet carrier or the cover to achieve different reduction ratios of the respective planetary gearset system,
wherein the respective planetary gearset system is rendered inactive in response to axially moving the respective synchronizer toward the planet carrier and engaging the planet carrier of the planetary gearset system, and wherein the respective planetary gearset system is rendered active in response to axially moving the respective synchronizer toward the cover and engaging the cover.

13. (canceled)

14. A line of axle systems, comprising:
a first transmission, a second transmission, and a third transmission, each of the first transmission, the second transmission, and the third transmission comprising:
a housing comprising at least a first cover positioned on one side of a respective transmission that circumferentially encloses the respective transmission, a position of a first cover being the same for each of the first transmission, the second transmission, and the third transmission;
an electric motor rotationally coupled to a motor shaft, the motor shaft being coupled to an input shaft via splines and a carrier and the electric motor being positioned on an opposite side of the respective transmission relative to the first cover;
a pair of helical gears positioned on a same side of the respective transmission as the first cover and comprising a first helical gear positioned in a top half and a second helical gear positioned in a bottom half of the respective transmission that engage with each other and neither of the first helical gear and the second helical gear is coupled to the input shaft; and
a pinion gear positioned on the same side of the respective transmission as the first cover and coupled to the second helical gear via a spline and engages with a ring gear, the ring gear being coupled to a differential in a center region of the respective transmission.

15. The line of electric axles of claim 14, wherein the first transmission and the second transmission further comprises:
the electric motor being positioned in the top half of the respective transmission;
the electric motor not being positioned in the bottom half of the respective transmission;
the housing not comprising a second cover positioned on another side of the respective transmission relative to the first cover;
wherein a third helical gear is not engaged with external teeth of a second annulus gear of a second planetary gearset system and the second planetary gearset system is not located in the top half and positioned on the same side as the second cover of the respective transmission,
wherein a second synchronizer is not coupled to a second sun gear of the second planetary gearset system and a second planet carrier does not engage with an intermediate shaft via splines; and
wherein the intermediate shaft is not coupled to a first annulus gear of a first planetary gearset system via splines.

16. The line of electric axles of claim 15, wherein the first transmission further comprises:
the input shaft being coupled to an output shaft;
the first helical gear being coupled to the output shaft via splines on the same side of the respective transmission as the first cover;
the input shaft not being coupled to the first annulus gear of the first planetary gearset system located in the top half and positioned on the same side as the first cover;
wherein the first helical gear is not coupled to a first planet carrier of the first planetary gearset system via splines;
the input shaft not being coupled to the third helical gear positioned on the opposite side of the respective transmission relative to the first cover and located in the bottom half of the respective transmission;
wherein a first synchronizer is not located in the top half and positioned on the same side as the first cover of the respective transmission and coupled to a first sun gear of the first planetary gearset system.

17. The line of electric axles of claim 16, wherein the second transmission and the third transmission further comprise:
the input shaft not being coupled to the output shaft and the first helical gear not being coupled to the output shaft via splines on the same side of the respective transmission as the first cover;
the first planetary gearset system being located in the top half and positioned on the same side as the first cover of the respective transmission, the first planetary gearset system comprising the first annulus gear, the first sun gear, the first planet carrier, and a first set of planet gears;
the first synchronizer located in the top half and positioned on the same side as the first cover of the respective transmission and coupled to the first sun gear of the first planetary gearset system; and
the first helical gear being coupled to the first planet carrier via splines.

18. The line of electric axles of claim 17, wherein the second transmission includes the input shaft being coupled to the first annulus gear of the first planetary gearset system via splines and not being coupled to the third helical gear positioned on the opposite side of the respective relative to the first cover and located in the bottom half of the respective transmission, and the third transmission includes the input shaft being coupled to the third helical gear.

19. The line of electric axles of claim 18, wherein the third transmission further comprises:
the housing further comprises the second cover positioned on another side of the respective transmission;
the electric motor being located in the bottom half of the respective transmission;
the electric motor not being located in the top half of the respective transmission;
the third helical gear being engaged with external teeth of the second annulus gear of the second planetary gearset system, the second planetary gearset system being located in the top half, positioned on the same side as the second cover of the respective transmission, and comprising the second annulus gear, a second set of planet gears, the second planet carrier, and the second sun gear; and
the second synchronizer coupled to the second sun gear of the second planetary gearset system.

20. The line of electric axles of claim 19, wherein the third transmission further comprises:
the second planet carrier engaging with the intermediate shaft via splines; and
the intermediate shaft being coupled to the first annulus gear of the first planetary gearset system via splines.
